(19) United States
(12) Patent Application Publication
(10) Pub. No.: US 2024/0373034 A1
(43) Pub. Date: Nov. 7, 2024

(54) IMAGE ENCODING/DECODING METHOD, METHOD FOR TRANSMITTING BITSTREAM, AND RECORDING MEDIUM IN WHICH BITSTREAM IS STORED

(71) Applicant: LG Electronics Inc., Seoul (KR)

(72) Inventors: Jung Hak NAM, Seoul (KR); Sunmi YOO, Seoul (KR); Jaehyun LIM, Seoul (KR); Seung Hwan KIM, Seoul (KR)

(21) Appl. No.: 18/689,337

(22) PCT Filed: Sep. 21, 2022
(86) PCT No.: PCT/KR2022/014111

§ 371 Date: Mar. 5, 2024

Related U.S. Application Data
(60) Provisional application No. 63/247,319, filed on Sep. 23, 2021.

(51) Int. Cl. H04N 19/147; H04N 19/103; H04N 19/124; H04N 19/132; H04N 19/14; H04N 19/184

(52) U.S. Cl. CPC H04N 19/147; H04N 19/103; H04N 19/124; H04N 19/132; H04N 19/14; H04N 19/184

(57) ABSTRACT

An image encoding/decoding method, a bitstream transmission method, and a computer-readable recording medium for storing a bitstream are provided. An image encoding method according to the present disclosure is an image encoding method performed by an image encoding device, and may be an image encoding method comprising the steps of: obtaining information on the similarity between a current image and a reference image and information on the complexity of the current image; predicting bitrate information and distortion information of one or more candidate resolutions on the basis of the information on the similarity and the information on the complexity; and selecting a resolution to be applied to the current image among the candidate resolutions on the basis of the bitrate information and the distortion information.

### TECHNICAL FIELD

The present disclosure relates to an image encoding/decoding method, a method of transmitting a bitstream and a recording medium storing a bitstream and relates to reference picture resampling (RPR).

### BACKGROUND

Recently, demand for high-resolution and high-quality images such as high definition (HD) images and ultra high definition (UHD) images is increasing in various fields. As resolution and quality of image data are improved, the amount of transmitted information or bits relatively increases as compared to existing image data. An increase in the amount of transmitted information or bits causes an increase in transmission cost and storage cost.

Accordingly, there is a need for high-efficient image compression technology for effectively transmitting, storing and reproducing information on high-resolution and high-quality images.

### SUMMARY

An object of the present disclosure is to provide an image encoding/decoding method and apparatus with improved encoding/decoding efficiency.

An object of the present disclosure is to provide a method of adaptively determining an optimal resolution.

An object of the present disclosure is to provide a method of determining an optimal resolution by considering image complexity and similarity.

An object of the present disclosure is to provide a method of determining an optimal resolution by considering an expected bit amount and expected distortion for each of selectable resolutions.

An object of the present disclosure is to provide a method of determining an optimal resolution that minimizes rate distortion cost.

Another object of the present disclosure is to provide a non-transitory computer-readable recording medium storing a bitstream generated by an image encoding method according to the present disclosure.

Another object of the present disclosure is to provide a non-transitory computer-readable recording medium storing a bitstream received, decoded and used to reconstruct an image by an image decoding apparatus according to the present disclosure.

Another object of the present disclosure is to provide a method of transmitting a bitstream generated by an image encoding method or apparatus according to the present disclosure.

The technical problems solved by the present disclosure are not limited to the above technical problems and other technical problems which are not described herein will become apparent to those skilled in the art from the following description.

An image encoding method according to an aspect of the present disclosure is an image encoding method performed by an image encoding apparatus, and the image encoding method may comprise obtaining information on similarity between a current image and a reference image and information on complexity of the current image, predicting bit rate information and distortion information of one or more candidate resolutions based on the information on similarity and the information on complexity, and selecting a resolution to be applied to the current image from among the candidate resolutions based on the bit rate information and the distortion information.

A computer-readable recording medium according to another aspect of the present disclosure may store a bitstream generated by the image encoding device or apparatus of the present disclosure.

A transmission method according to another aspect of the present disclosure may transmit a bitstream generated by the image encoding method or apparatus of the present disclosure.

The features briefly summarized above with respect to the present disclosure are merely exemplary aspects of the detailed description below of the present disclosure, and do not limit the scope of the present disclosure.

According to the present disclosure, it is possible to provide an image encoding/decoding method and apparatus with improved encoding/decoding efficiency.

According to the present disclosure, it is possible to efficiently derive an optimal resolution.

According to the present disclosure, it is possible to improve complexity for determining an optimal resolution.

It will be appreciated by persons skilled in the art that that the effects that can be achieved through the present disclosure are not limited to what has been particularly described hereinabove and other advantages of the present disclosure will be more clearly understood from the detailed description.

### BRIEF DESCRIPTION OF THE DRAWINGS

FIG. 1 is a view schematically illustrating a video coding system, to which an embodiment of the present disclosure is applicable.

FIG. 2 is a view schematically illustrating an image encoding apparatus, to which an embodiment of the present disclosure is applicable.

FIG. 3 is a view schematically illustrating an image decoding apparatus, to which an embodiment of the present disclosure is applicable.

FIG. 4 is a diagram showing an example of partitioning a picture into CTUs.

FIG. 5 is a diagram showing examples of partitioning a picture into tiles, slices and/or bricks.

FIG. 6 is a diagram schematically showing a configuration for determining an optimal resolution.

FIG. 7 is a flowchart illustrating an image encoding method according to an embodiment of the present disclosure.

FIG. 8 is a flowchart illustrating an image decoding method according to an embodiment of the present disclosure.

FIG. 9 is a diagram for explaining the positions of a current sample and neighboring samples which may be used to obtain complexity and similarity.

FIG. 10 is a flowchart illustrating an image encoding method according to another embodiment of the present disclosure.

FIG. 11 is a view illustrating a content streaming system, to which an embodiment of the present disclosure is applicable.

### DETAILED DESCRIPTION

Hereinafter, the embodiments of the present disclosure will be described in detail with reference to the accompanying drawings so as to be easily implemented by those skilled in the art. However, the present disclosure may be implemented in various different forms, and is not limited to the embodiments described herein.

In describing the present disclosure, if it is determined that the detailed description of a related known function or construction renders the scope of the present disclosure unnecessarily ambiguous, the detailed description thereof will be omitted. In the drawings, parts not related to the description of the present disclosure are omitted, and similar reference numerals are attached to similar parts.

In the present disclosure, when a component is “connected”, “coupled” or “linked” to another component, it may include not only a direct connection relationship but also an indirect connection relationship in which an intervening component is present. In addition, when a component “includes” or “has” other components, it means that other components may be further included, rather than excluding other components unless otherwise stated.

In the present disclosure, the terms first, second, etc. may be used only for the purpose of distinguishing one component from other components, and do not limit the order or importance of the components unless otherwise stated. Accordingly, within the scope of the present disclosure, a first component in one embodiment may be referred to as a second component in another embodiment, and similarly, a second component in one embodiment may be referred to as a first component in another embodiment.

In the present disclosure, components that are distinguished from each other are intended to clearly describe each feature, and do not mean that the components are necessarily separated. That is, a plurality of components may be integrated and implemented in one hardware or software unit, or one component may be distributed and implemented in a plurality of hardware or software units. Therefore, even if not stated otherwise, such embodiments in which the components are integrated or the component is distributed are also included in the scope of the present disclosure.

In the present disclosure, the components described in various embodiments do not necessarily mean essential components, and some components may be optional components. Accordingly, an embodiment consisting of a subset of components described in an embodiment is also included in the scope of the present disclosure. In addition, embodiments including other components in addition to components described in the various embodiments are included in the scope of the present disclosure.

The present disclosure relates to encoding and decoding of an image, and terms used in the present disclosure may have a general meaning commonly used in the technical field, to which the present disclosure belongs, unless newly defined in the present disclosure.

In the present disclosure, a “picture” generally refers to a unit representing one image in a specific time period, and a slice/tile is a coding unit constituting a part of a picture, and one picture may be composed of one or more slices/tiles. In addition, a slice/tile may include one or more coding tree units (CTUs).

In the present disclosure, a “pixel” or a “pel” may mean a smallest unit constituting one picture (or image). In addition, “sample” may be used as a term corresponding to a pixel. A sample may generally represent a pixel or a value of a pixel, and may represent only a pixel/pixel value of a luma component or only a pixel/pixel value of a chroma component.

In the present disclosure, a “unit” may represent a basic unit of image processing. The unit may include at least one of a specific region of the picture and information related to the region. The unit may be used interchangeably with terms such as “sample array”, “block” or “area” in some cases. In a general case, an M×N block may include samples (or sample arrays) or a set (or array) of transform coefficients of M columns and N rows.

In the present disclosure, “current block” may mean one of “current coding block”, “current coding unit”, “coding target block”, “decoding target block” or “processing target block”. When prediction is performed, “current block” may mean “current prediction block” or “prediction target block”. When transform (inverse transform)/quantization (dequantization) is performed, “current block” may mean “current transform block” or “transform target block”. When filtering is performed, “current block” may mean “filtering target block”.

In addition, in the present disclosure, a “current block” may mean a block including both a luma component block and a chroma component block or “a luma block of a current block” unless explicitly stated as a chroma block. The luma component block of the current block may be expressed by including an explicit description of a luma component block such as “luma block” or “current luma block. In addition, the “chroma component block of the current block” may be expressed by including an explicit description of a chroma component block, such as “chroma block” or “current chroma block”.

In the present disclosure, the term “/” and “,” should be interpreted to indicate “and/or.” For instance, the expression “A/B” and “A, B” may mean “A and/or B.” Further, “A/B/C” and “A/B/C” may mean “at least one of A, B, and/or C.”

In the present disclosure, the term “or” should be interpreted to indicate “and/or.” For instance, the expression “A or B” may comprise 1) only “A”, 2) only “B”, and/or 3) both “A and B”. In other words, in the present disclosure, the term “or” should be interpreted to indicate “additionally or alternatively.”

### Overview of Video Coding System

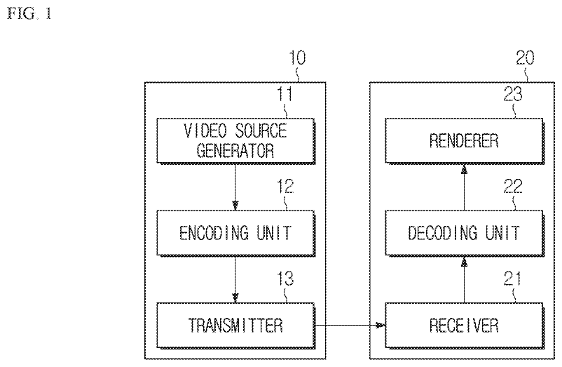

FIG. 1 is a view schematically illustrating a video coding system, to which an embodiment of the present disclosure is applicable.

The video coding system according to an embodiment may include a encoding apparatus 10 and a decoding apparatus 20. The encoding apparatus 10 may deliver encoded video and/or image information or data to the decoding apparatus 20 in the form of a file or streaming via a digital storage medium or network.

The encoding apparatus 10 according to an embodiment may include a video source generator 11, an encoding unit 12 and a transmitter 13. The decoding apparatus 20 according to an embodiment may include a receiver 21, a decoding unit 22 and a renderer 23. The encoding unit 12 may be called a video/image encoding unit, and the decoding unit 22 may be called a video/image decoding unit. The transmitter 13 may be included in the encoding unit 12. The receiver 21 may be included in the decoding unit 22. The renderer 23 may include a display and the display may be configured as a separate device or an external component.

The video source generator 11 may acquire a video/image through a process of capturing, synthesizing or generating the video/image. The video source generator 11 may include a video/image capture device and/or a video/image generating device. The video/image capture device may include, for example, one or more cameras, video/image archives including previously captured video/images, and the like. The video/image generating device may include, for example, computers, tablets and smartphones, and may (electronically) generate video/images. For example, a virtual video/image may be generated through a computer or the like. In this case, the video/image capturing process may be replaced by a process of generating related data.

The encoding unit 12 may encode an input video/image. The encoding unit 12 may perform a series of procedures such as prediction, transform, and quantization for compression and coding efficiency. The encoding unit 12 may output encoded data (encoded video/image information) in the form of a bitstream.

The transmitter 13 may transmit the encoded video/image information or data output in the form of a bitstream to the receiver 21 of the decoding apparatus 20 through a digital storage medium or a network in the form of a file or streaming. The digital storage medium may include various storage mediums such as USB, SD, CD, DVD, Blu-ray, HDD, SSD, and the like. The transmitter 13 may include an element for generating a media file through a predetermined file format and may include an element for transmission through a broadcast/communication network. The receiver 21 may extract/receive the bitstream from the storage medium or network and transmit the bitstream to the decoding unit 22.

The decoding unit 22 may decode the video/image by performing a series of procedures such as dequantization, inverse transform, and prediction corresponding to the operation of the encoding unit 12.

The renderer 23 may render the decoded video/image. The rendered video/image may be displayed through the display.

### Overview of Image Encoding Apparatus

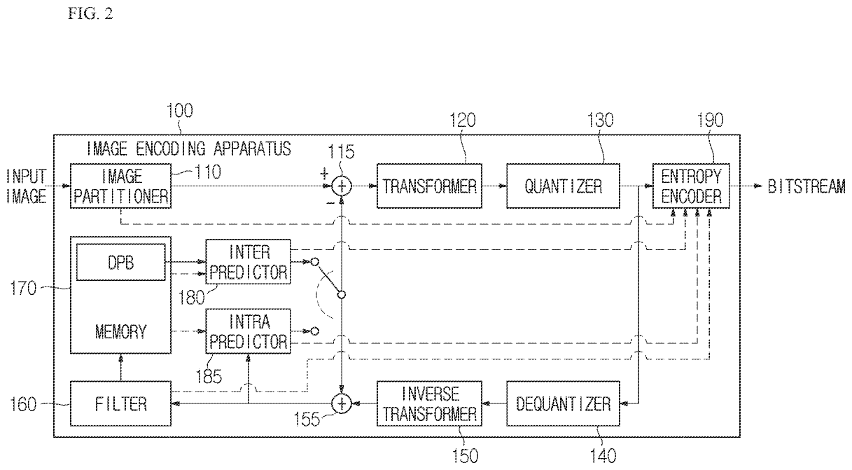

FIG. 2 is a view schematically illustrating an image encoding apparatus, to which an embodiment of the present disclosure is applicable.

As shown in FIG. 2, the image encoding apparatus 100 may include an image partitioner 110, a subtractor 115, a transformer 120, a quantizer 130, a dequantizer 140, an inverse transformer 150, an adder 155, a filter 160, a memory 170, an inter predictor 180, an intra predictor 185 and an entropy encoder 190. The inter predictor 180 and the intra predictor 185 may be collectively referred to as a “predictor”. The transformer 120, the quantizer 130, the dequantizer 140 and the inverse transformer 150 may be included in a residual processor. The residual processor may further include the subtractor 115.

All or at least some of the plurality of components configuring the image encoding apparatus 100 may be configured by one hardware component (e.g., an encoder or a processor) in some embodiments. In addition, the memory 170 may include a decoded picture buffer (DPB) and may be configured by a digital storage medium.

The image partitioner 110 may partition an input image (or a picture or a frame) input to the image encoding apparatus 100 into one or more processing units. For example, the processing unit may be called a coding unit (CU). The coding unit may be acquired by recursively partitioning a coding tree unit (CTU) or a largest coding unit (LCU) according to a quad-tree binary-tree ternary-tree (QT/BT/TT) structure. For example, one coding unit may be partitioned into a plurality of coding units of a deeper depth based on a quad tree structure, a binary tree structure, and/or a ternary structure For partitioning of the coding unit, a quad tree structure may be applied first and the binary tree structure and/or ternary structure may be applied later. The coding procedure according to the present disclosure may be performed based on the final coding unit that is no longer partitioned. The largest coding unit may be used as the final coding unit or the coding unit of deeper depth acquired by partitioning the largest coding unit may be used as the final coding unit. Here, the coding procedure may include a procedure of prediction, transform, and reconstruction, which will be described later. As another example, the processing unit of the coding procedure may be a prediction unit (PU) or a transform unit (TU). The prediction unit and the transform unit may be split or partitioned from the final coding unit. The prediction unit may be a unit of sample prediction, and the transform unit may be a unit for deriving a transform coefficient and/or a unit for deriving a residual signal from the transform coefficient.

The predictor (the inter predictor 180 or the intra predictor 185) may perform prediction on a block to be processed (current block) and generate a predicted block including prediction samples for the current block. The predictor may determine whether intra prediction or inter prediction is applied on a current block or CU basis. The predictor may generate various information related to prediction of the current block and transmit the generated information to the entropy encoder 190. The information on the prediction may be encoded in the entropy encoder 190 and output in the form of a bitstream.

The intra predictor 185 may predict the current block by referring to the samples in the current picture. The referred samples may be located in the neighborhood of the current block or may be located apart according to the intra prediction mode and/or the intra prediction technique. The intra prediction modes may include a plurality of non-directional modes and a plurality of directional modes. The non-directional mode may include, for example, a DC mode and a planar mode. The directional mode may include, for example, 33 directional prediction modes or 65 directional prediction modes according to the degree of detail of the prediction direction. However, this is merely an example, more or less directional prediction modes may be used depending on a setting. The intra predictor 185 may determine the prediction mode applied to the current block by using a prediction mode applied to a neighboring block.

The inter predictor 180 may derive a predicted block for the current block based on a reference block (reference sample array) specified by a motion vector on a reference picture. In this case, in order to reduce the amount of motion information transmitted in the inter prediction mode, the motion information may be predicted in units of blocks, subblocks, or samples based on correlation of motion information between the neighboring block and the current block. The motion information may include a motion vector and a reference picture index. The motion information may further include inter prediction direction (L0 prediction, L1 prediction, Bi prediction, etc.) information. In the case of inter prediction, the neighboring block may include a spatial neighboring block present in the current picture and a temporal neighboring block present in the reference picture. The reference picture including the reference block and the reference picture including the temporal neighboring block may be the same or different. The temporal neighboring block may be called a collocated reference block, a co-located CU (colCU), and the like. The reference picture including the temporal neighboring block may be called a collocated picture (colPic). For example, the inter predictor 180 may configure a motion information candidate list based on neighboring blocks and generate information indicating which candidate is used to derive a motion vector and/or a reference picture index of the current block. Inter prediction may be performed based on various prediction modes. For example, in the case of a skip mode and a merge mode, the inter predictor 180 may use motion information of the neighboring block as motion information of the current block. In the case of the skip mode, unlike the merge mode, the residual signal may not be transmitted. In the case of the motion vector prediction (MVP) mode, the motion vector of the neighboring block may be used as a motion vector predictor, and the motion vector of the current block may be signaled by encoding a motion vector difference and an indicator for a motion vector predictor. The motion vector difference may mean a difference between the motion vector of the current block and the motion vector predictor.

The predictor may generate a prediction signal based on various prediction methods and prediction techniques described below. For example, the predictor may not only apply intra prediction or inter prediction but also simultaneously apply both intra prediction and inter prediction, in order to predict the current block. A prediction method of simultaneously applying both intra prediction and inter prediction for prediction of the current block may be called combined inter and intra prediction (CIIP). In addition, the predictor may perform intra block copy (IBC) for prediction of the current block. Intra block copy may be used for content image/video coding of a game or the like, for example, screen content coding (SCC). IBC is a method of predicting a current picture using a previously reconstructed reference block in the current picture at a location apart from the current block by a predetermined distance. When IBC is applied, the location of the reference block in the current picture may be encoded as a vector (block vector) corresponding to the predetermined distance. IBC basically performs prediction in the current picture, but may be performed similarly to inter prediction in that a reference block is derived within the current picture. That is, IBC may use at least one of the inter prediction techniques described in the present disclosure.

The prediction signal generated by the predictor may be used to generate a reconstructed signal or to generate a residual signal. The subtractor 115 may generate a residual signal (residual block or residual sample array) by subtracting the prediction signal (predicted block or prediction sample array) output from the predictor from the input image signal (original block or original sample array). The generated residual signal may be transmitted to the transformer 120.

The transformer 120 may generate transform coefficients by applying a transform technique to the residual signal. For example, the transform technique may include at least one of a discrete cosine transform (DCT), a discrete sine transform (DST), a karhunen-loève transform (KLT), a graph-based transform (GBT), or a conditionally non-linear transform (CNT). Here, the GBT means transform obtained from a graph when relationship information between pixels is represented by the graph. The CNT refers to transform acquired based on a prediction signal generated using all previously reconstructed pixels. In addition, the transform process may be applied to square pixel blocks having the same size or may be applied to blocks having a variable size rather than square.

The quantizer 130 may quantize the transform coefficients and transmit them to the entropy encoder 190. The entropy encoder 190 may encode the quantized signal (information on the quantized transform coefficients) and output a bitstream. The information on the quantized transform coefficients may be referred to as residual information. The quantizer 130 may rearrange quantized transform coefficients in a block type into a one-dimensional vector form based on a coefficient scanning order and generate information on the quantized transform coefficients based on the quantized transform coefficients in the one-dimensional vector form.

The entropy encoder 190 may perform various encoding methods such as, for example, exponential Golomb, context-adaptive variable length coding (CAVLC), context-adaptive binary arithmetic coding (CABAC), and the like. The entropy encoder 190 may encode information necessary for video/image reconstruction other than quantized transform coefficients (e.g., values of syntax elements, etc.) together or separately. Encoded information (e.g., encoded video/image information) may be transmitted or stored in units of network abstraction layers (NALs) in the form of a bitstream. The video/image information may further include information on various parameter sets such as an adaptation parameter set (APS), a picture parameter set (PPS), a sequence parameter set (SPS), or a video parameter set (VPS). In addition, the video/image information may further include general constraint information. The signaled information, transmitted information and/or syntax elements described in the present disclosure may be encoded through the above-described encoding procedure and included in the bitstream.

The bitstream may be transmitted over a network or may be stored in a digital storage medium. The network may include a broadcasting network and/or a communication network, and the digital storage medium may include various storage media such as USB, SD, CD, DVD, Blu-ray, HDD, SSD, and the like. A transmitter (not shown) transmitting a signal output from the entropy encoder 190 and/or a storage unit (not shown) storing the signal may be included as internal/external element of the image encoding apparatus 100. Alternatively, the transmitter may be provided as the component of the entropy encoder 190.

The quantized transform coefficients output from the quantizer 130 may be used to generate a residual signal. For example, the residual signal (residual block or residual samples) may be reconstructed by applying dequantization and inverse transform to the quantized transform coefficients through the dequantizer 140 and the inverse transformer 150.

The adder 155 adds the reconstructed residual signal to the prediction signal output from the inter predictor 180 or the intra predictor 185 to generate a reconstructed signal (reconstructed picture, reconstructed block, reconstructed sample array). If there is no residual for the block to be processed, such as a case where the skip mode is applied, the predicted block may be used as the reconstructed block. The adder 155 may be called a reconstructor or a reconstructed block generator. The generated reconstructed signal may be used for intra prediction of a next block to be processed in the current picture and may be used for inter prediction of a next picture through filtering as described below.

The filter 160 may improve subjective/objective image quality by applying filtering to the reconstructed signal. For example, the filter 160 may generate a modified reconstructed picture by applying various filtering methods to the reconstructed picture and store the modified reconstructed picture in the memory 170, specifically, a DPB of the memory 170. The various filtering methods may include, for example, deblocking filtering, a sample adaptive offset, an adaptive loop filter, a bilateral filter, and the like. The filter 160 may generate various information related to filtering and transmit the generated information to the entropy encoder 190 as described later in the description of each filtering method. The information related to filtering may be encoded by the entropy encoder 190 and output in the form of a bitstream.

The modified reconstructed picture transmitted to the memory 170 may be used as the reference picture in the inter predictor 180. When inter prediction is applied through the image encoding apparatus 100, prediction mismatch between the image encoding apparatus 100 and the image decoding apparatus may be avoided and encoding efficiency may be improved.

The DPB of the memory 170 may store the modified reconstructed picture for use as a reference picture in the inter predictor 180. The memory 170 may store the motion information of the block from which the motion information in the current picture is derived (or encoded) and/or the motion information of the blocks in the picture that have already been reconstructed. The stored motion information may be transmitted to the inter predictor 180 and used as the motion information of the spatial neighboring block or the motion information of the temporal neighboring block. The memory 170 may store reconstructed samples of reconstructed blocks in the current picture and may transfer the reconstructed samples to the intra predictor 185.

### Overview of Image Decoding Apparatus

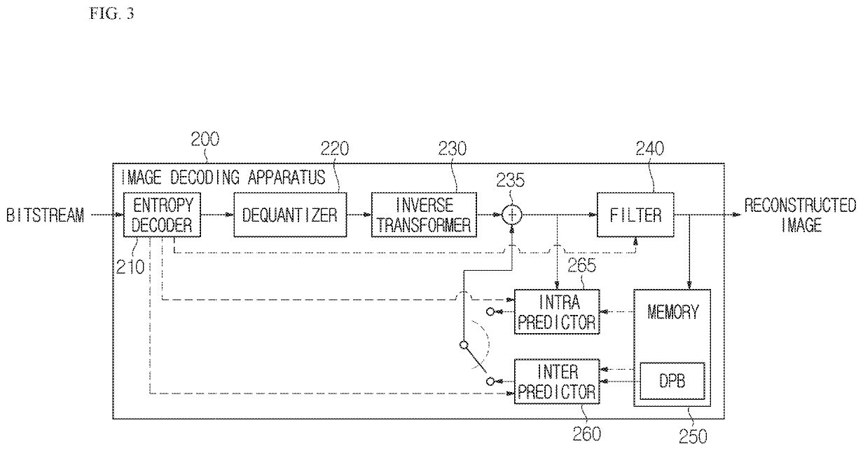

FIG. 3 is a view schematically illustrating an image decoding apparatus, to which an embodiment of the present disclosure is applicable.

As shown in FIG. 3, the image decoding apparatus 200 may include an entropy decoder 210, a dequantizer 220, an inverse transformer 230, an adder 235, a filter 240, a memory 250, an inter predictor 260 and an intra predictor 265. The inter predictor 260 and the intra predictor 265 may be collectively referred to as a “predictor”. The dequantizer 220 and the inverse transformer 230 may be included in a residual processor.

All or at least some of a plurality of components configuring the image decoding apparatus 200 may be configured by a hardware component (e.g., a decoder or a processor) according to an embodiment. In addition, the memory 250 may include a decoded picture buffer (DPB) or may be configured by a digital storage medium.

The image decoding apparatus 200, which has received a bitstream including video/image information, may reconstruct an image by performing a process corresponding to a process performed by the image encoding apparatus 100 of FIG. 2. For example, the image decoding apparatus 200 may perform decoding using a processing unit applied in the image encoding apparatus. Thus, the processing unit of decoding may be a coding unit, for example. The coding unit may be acquired by partitioning a coding tree unit or a largest coding unit. The reconstructed image signal decoded and output through the image decoding apparatus 200 may be reproduced through a reproducing apparatus (not shown).

The image decoding apparatus 200 may receive a signal output from the image encoding apparatus of FIG. 2 in the form of a bitstream. The received signal may be decoded through the entropy decoder 210. For example, the entropy decoder 210 may parse the bitstream to derive information (e.g., video/image information) necessary for image reconstruction (or picture reconstruction). The video/image information may further include information on various parameter sets such as an adaptation parameter set (APS), a picture parameter set (PPS), a sequence parameter set (SPS), or a video parameter set (VPS). In addition, the video/image information may further include general constraint information. The image decoding apparatus may further decode picture based on the information on the parameter set and/or the general constraint information. Signaled/received information and/or syntax elements described in the present disclosure may be decoded through the decoding procedure and obtained from the bitstream. For example, the entropy decoder 210 decodes the information in the bitstream based on a coding method such as exponential Golomb coding, CAVLC, or CABAC, and output values of syntax elements required for image reconstruction and quantized values of transform coefficients for residual. More specifically, the CABAC entropy decoding method may receive a bin corresponding to each syntax element in the bitstream, determine a context model using a decoding target syntax element information, decoding information of a neighboring block and a decoding target block or information of a symbol/bin decoded in a previous stage, and perform arithmetic decoding on the bin by predicting a probability of occurrence of a bin according to the determined context model, and generate a symbol corresponding to the value of each syntax element. In this case, the CABAC entropy decoding method may update the context model by using the information of the decoded symbol/bin for a context model of a next symbol/bin after determining the context model. The information related to the prediction among the information decoded by the entropy decoder 210 may be provided to the predictor (the inter predictor 260 and the intra predictor 265), and the residual value on which the entropy decoding was performed in the entropy decoder 210, that is, the quantized transform coefficients and related parameter information, may be input to the dequantizer 220. In addition, information on filtering among information decoded by the entropy decoder 210 may be provided to the filter 240. Meanwhile, a receiver (not shown) for receiving a signal output from the image encoding apparatus may be further configured as an internal/external element of the image decoding apparatus 200, or the receiver may be a component of the entropy decoder 210.

Meanwhile, the image decoding apparatus according to the present disclosure may be referred to as a video/image/picture decoding apparatus. The image decoding apparatus may be classified into an information decoder (video/image/picture information decoder) and a sample decoder (video/image/picture sample decoder). The information decoder may include the entropy decoder 210. The sample decoder may include at least one of the dequantizer 220, the inverse transformer 230, the adder 235, the filter 240, the memory 250, the inter predictor 160 or the intra predictor 265.

The dequantizer 220 may dequantize the quantized transform coefficients and output the transform coefficients. The dequantizer 220 may rearrange the quantized transform coefficients in the form of a two-dimensional block. In this case, the rearrangement may be performed based on the coefficient scanning order performed in the image encoding apparatus. The dequantizer 220 may perform dequantization on the quantized transform coefficients by using a quantization parameter (e.g., quantization step size information) and obtain transform coefficients.

The inverse transformer 230 may inversely transform the transform coefficients to obtain a residual signal (residual block, residual sample array).

The predictor may perform prediction on the current block and generate a predicted block including prediction samples for the current block. The predictor may determine whether intra prediction or inter prediction is applied to the current block based on the information on the prediction output from the entropy decoder 210 and may determine a specific intra/inter prediction mode (prediction technique).

It is the same as described in the predictor of the image encoding apparatus 100 that the predictor may generate the prediction signal based on various prediction methods (techniques) which will be described later.

The intra predictor 265 may predict the current block by referring to the samples in the current picture. The description of the intra predictor 185 is equally applied to the intra predictor 265.

The inter predictor 260 may derive a predicted block for the current block based on a reference block (reference sample array) specified by a motion vector on a reference picture. In this case, in order to reduce the amount of motion information transmitted in the inter prediction mode, motion information may be predicted in units of blocks, subblocks, or samples based on correlation of motion information between the neighboring block and the current block. The motion information may include a motion vector and a reference picture index. The motion information may further include inter prediction direction (L0 prediction, L1 prediction, Bi prediction, etc.) information. In the case of inter prediction, the neighboring block may include a spatial neighboring block present in the current picture and a temporal neighboring block present in the reference picture. For example, the inter predictor 260 may configure a motion information candidate list based on neighboring blocks and derive a motion vector of the current block and/or a reference picture index based on the received candidate selection information. Inter prediction may be performed based on various prediction modes, and the information on the prediction may include information indicating a mode of inter prediction for the current block.

The adder 235 may generate a reconstructed signal (reconstructed picture, reconstructed block, reconstructed sample array) by adding the obtained residual signal to the prediction signal (predicted block, predicted sample array) output from the predictor (including the inter predictor 260 and/or the intra predictor 265). If there is no residual for the block to be processed, such as when the skip mode is applied, the predicted block may be used as the reconstructed block. The description of the adder 155 is equally applicable to the adder 235. The adder 235 may be called a reconstructor or a reconstructed block generator. The generated reconstructed signal may be used for intra prediction of a next block to be processed in the current picture and may be used for inter prediction of a next picture through filtering as described below.

The filter 240 may improve subjective/objective image quality by applying filtering to the reconstructed signal. For example, the filter 240 may generate a modified reconstructed picture by applying various filtering methods to the reconstructed picture and store the modified reconstructed picture in the memory 250, specifically, a DPB of the memory 250. The various filtering methods may include, for example, deblocking filtering, a sample adaptive offset, an adaptive loop filter, a bilateral filter, and the like.

The (modified) reconstructed picture stored in the DPB of the memory 250 may be used as a reference picture in the inter predictor 260. The memory 250 may store the motion information of the block from which the motion information in the current picture is derived (or decoded) and/or the motion information of the blocks in the picture that have already been reconstructed. The stored motion information may be transmitted to the inter predictor 260 so as to be utilized as the motion information of the spatial neighboring block or the motion information of the temporal neighboring block. The memory 250 may store reconstructed samples of reconstructed blocks in the current picture and transfer the reconstructed samples to the intra predictor 265.

In the present disclosure, the embodiments described in the filter 160, the inter predictor 180, and the intra predictor 185 of the image encoding apparatus 100 may be equally or correspondingly applied to the filter 240, the inter predictor 260, and the intra predictor 265 of the image decoding apparatus 200.

### Overview of Picture Partitioning

The video/image encoding/decoding method according to the present disclosure may be performed based on a partitioning structure. Specifically, procedures such as prediction, residual processing ((inverse) transform, (de)quantization, etc.), syntax element coding, and filtering may be performed based on a CTU, CU (and/or TU, PU) derived based on the partitioning structure.

The block partitioning procedure may be performed in the image partitioner 110 of the image encoding apparatus. The partitioning related information may be encoded by the entropy encoder 190 and transferred to the image decoding apparatus 200 in the form of a bitstream. The entropy decoder 210 of the image decoding apparatus 200 may derive a block partitioning structure of a current picture based on the partitioning related information obtained from the bitstream, and based on this, may perform a series of procedures (e.g., prediction, residual processing, block/picture reconstruction, in-loop filtering, etc.) for image decoding.

A CU size may be equal to a TU size or a plurality of TUs may be present in a CU region. Meanwhile, the CU size may generally indicate a luma component (sample) CB size. The TU size may generally indicate a luma component (sample) TB size. A chroma component (sample) CB or TB size may be derived based on a luma component (sample) CB or TB size according to a component ratio according to a color format (chroma format, e.g., 4:4:4, 4:2:2, 4:2:0, etc.) of a picture/image. The TU size may be derived based on maxTbSize. For example, when the CU size is greater than maxTbSize, a plurality of TUs (TBs) having maxTbSize may be derived from the CU, and transform/inverse transform may be performed in unit of TU (TB). In addition, for example, when intra prediction is applied, an intra prediction mode/type may be derived in unit of CU (or CB) and a neighboring reference sample derivation and prediction sample generation procedure may be performed in unit of TU (or TB). In this case, one or a plurality of TUs (or TBs) may be present in a CU (or a CB) region. In this case, the plurality of TUs (or TBs) may share the same intra prediction mode/type.

In addition, in video/image encoding and decoding according to the present disclosure, an image processing unit may have a hierarchical structure. One picture may be partitioned into one or more tiles, bricks, slices or tile groups. One brick may include one or more CTU rows in a tile. A slice may include an integer number of bricks of a picture. One tile group may include one or more tiles. One tile may include one or more CTUs. The CTU may be partitioned into one or more CUs. A rectangular region of CTUs within a particular tile column and a particular tile row in a picture. The tile group may include an integer number of tiles according to tile-raster scan within a picture. A slice header may carry information/parameters applicable to the slice (blocks within the slice).

When an image encoding/decoding apparatus 100 or 200 has a multi-core processor, an encoding/decoding procedure for the tile, slice, brick or tile group may be performed in parallel. In the present disclosure, the slice or the tile group may be used interchangeably. That is, the tile group header may be called a slice header. Here, the slice may have one of slice types including an intra (I) slice, a predictive (P) slice and a bi-predictive (B) slice. For blocks in the I slice, inter prediction may not be used and only intra prediction may be used for prediction. Of course, even in this case, an original sample value may be coded and signaled without prediction. For blocks in the P slice, intra prediction or inter prediction may be used, and only uni-prediction may be used when inter prediction is used. Meanwhile, for blocks in the B slice, intra prediction or inter prediction may be used, and up to bi prediction may be used when inter prediction is used.

In the image encoding apparatus 100, a tile/tile group, a brick, a slice, a maximum and minimum coding unit size may be determined according to the characteristics (e.g., resolution) of an image or in consideration of coding efficiency or parallel processing, and information thereon or information capable of deriving the same may be included in a bitstream.

In the image decoding apparatus 200, information indicating whether a tile/tile group, brick or slice of a current picture or a CTU in a tile is partitioned into a plurality of coding units may be obtained. When such information is obtained (transmitted) only under a specific condition, efficiency can increase.

The slice header (slice header syntax) may include information/parameter which is commonly applicable to the slice. The APS (APS syntax) or PPS (PPS syntax) may include information/parameter which is commonly applicable to one or more pictures. The SPS (SPS syntax) may include information/parameter which is commonly applicable to one or more sequences. The VPS (VPS syntax) may include information/parameter which is commonly applicable to multiple layers. The DPS (DPS syntax) may include information/parameter which is commonly applicable to the overall video. The DPS may include information/parameter related to concatenation of a coded video sequence (CVS).

In the present disclosure, a higher level syntax may include at least one of the APS syntax, the PPS syntax, the SPS syntax, the VPS syntax or the slice header syntax. In addition, for example, information on partitioning and configuration of the tile/tile group/brick/slice may be constructed in the image encoding apparatus 100 through the higher level syntax and transferred to the image decoding apparatus 200 in the form of a bitstream.

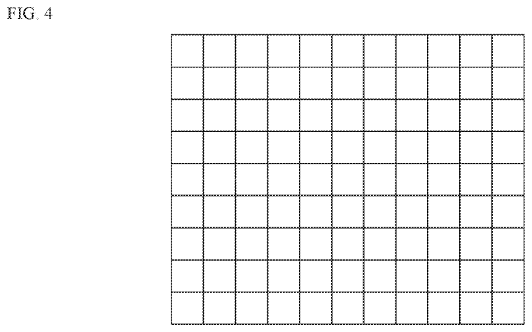

FIG. 4 is a diagram showing an example of partitioning a picture into CTUs. In FIG. 4, a rectangle formed by the outermost border represents a picture and rectangles included in the picture represent CTUs.

Referring to FIG. 4, pictures may be partitioned into a sequence of coding tree units (CTUs). A CTU may correspond to a coding tree block (CTB). Alternatively, the CTU may include a coding tree block of luma samples and two coding tree blocks of chroma samples corresponding thereto. In other words, for a picture containing a three-sample array, the CTU may include an N×N block of luma samples and two corresponding blocks of chroma samples.

The maximum allowable size of the CTU for coding and prediction may be different from the maximum allowable size of the CTU for transform. For example, even if the maximum allowable size of the CTU for transform is 64×64, the maximum allowable size of the luma block in the CTU for coding and prediction may be 128×128.

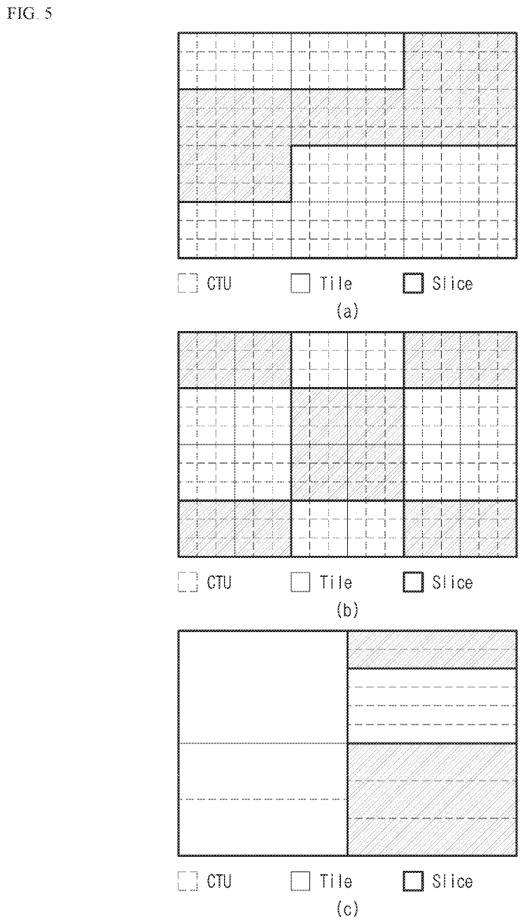

FIG. 5 is a diagram showing examples of partitioning a picture into tiles, slices and/or bricks.

Specifically, (a) of FIG. 5 shows an example of a picture (raster scan slice partition) partitioned into 12 tiles and 3 raster scan slices, and (b) of FIG. 5 shows an example of a picture (rectangular slice partition) partitioned into 24 tiles (6 tile columns and 4 tile rows) and 9 rectangular slices. Additionally, (c) of FIG. 5 shows an example of partitioning a picture into tiles, rectangular slices, and bricks, and in (c) of FIG. 5, the picture is partitioned into four tiles (two tile columns and two tile rows).), 11 bricks (1 brick included in the upper left tile, 5 bricks included in the upper right tile, 2 bricks included in the lower left tile, and 3 bricks included in the lower right tile), and four rectangular slices.

Referring to FIG. 5, the picture may be partitioned into one or more tile rows and one or more tile columns. One tile may be a sequence of CTUs covering a rectangular area of the picture. Depending on the embodiment, a tile may be partitioned into one or more bricks. Each brick may consist of multiple CTU rows within a tile. A tile that is not partitioned into a plurality of bricks may be a brick. However, a brick, which is a subset of tiles, do not correspond to a tile.

A slice may include a plurality of tiles within a picture or a plurality of bricks within a tile. Two slice modes may be supported: raster scan slice mode (raster scan slice) and rectangular slice mode (rectangular slice). In a raster scan slice, one slice may include a sequence of tiles within a tile raster scan of a picture. In a rectangular slice, one slice may include a plurality of bricks that collectively form a rectangular area of a picture. Bricks within a rectangular slice may have a brick raster scan order of the slice.

### Reference Picture Resampling (RPR)

The versatile video coding (VVC) video compression standard technology may use reference picture resampling (RPR) technology in one coded layer video sequence (CLVS). That is, the resolution of an image in one layer image may be changed.

In RPR, when the resolutions of a current image and a reference image are different, a resolution ratio between the reference image and the current image is calculated, and the resolution of the reference image may be changed to a resolution with the same size as the resolution of the current image through sampling. The reference image with the changed resolution may be referenced for encoding/decoding of the current image.

Additionally, in RPR, the resolution of the current image to be encoded may be selected, and after performing encoding on various resolutions (candidate resolutions), the optimal resolution of the current image may be determined based on the encoding result. Here, the condition for optimal resolution may be the best image quality at the same bit rate or the lowest bit rate at the same image quality.

However, when encoding all candidate resolutions to calculate the optimal resolution, the same picture must be encoded multiple times, which may increase complexity in terms of computation amount, time, and memory usage.

To avoid such an increase in complexity, a relatively simple method of determining an optimal resolution by periodic time (0.5 seconds, 1 second, etc.), predetermined number of frames (8, 16, 32, 64, 128, etc.), multiple of a GOP (group of picture), multiple of RAP (random access point), etc. be considered. However, this relatively simple method has the problem of not being able to accurately determine the optimal resolution.

The present application relates to a method of determining an optimal resolution when applying RPR technology. The present application can improve complexity by not having to perform encoding on each of candidate resolutions. In addition, in the present application, since the optimal resolution is determined based on the complexity of a current image, the similarity between the current image and a reference image, a predicted bit rate, and predicted distortion, the optimal resolution can be determined more accurately. Accordingly, the present application can provide a solution to the problems of the conventional resolution determination methods described above.

Hereinafter, various embodiments provided herein will be described. Various embodiments described below may be performed individually or may be performed by combining a plurality of embodiments.

### Embodiment 1

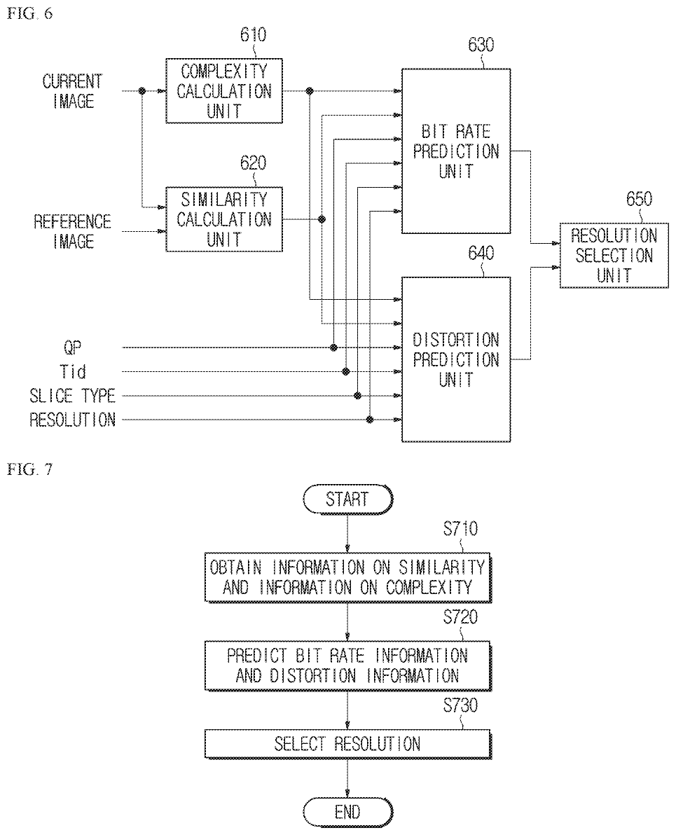

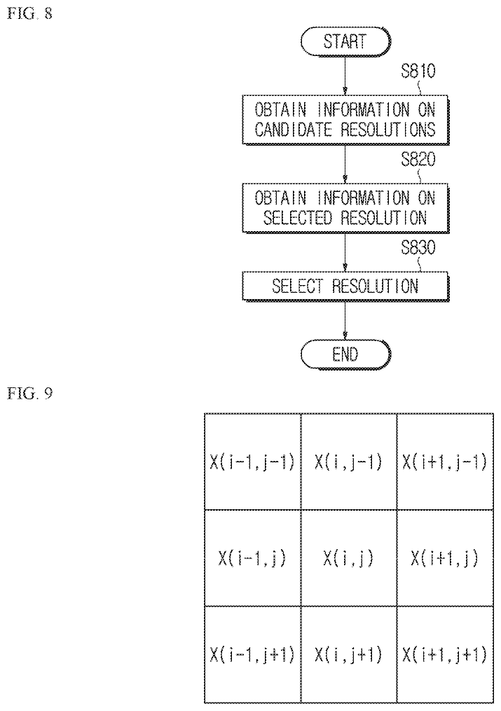

Embodiment 1 is an embodiment of a method of determining an optimal resolution. A configuration for implementing the method of determining the optimal resolution is shown in FIG. 6, an image encoding method according to Embodiment 1 is shown in FIG. 7, and an image decoding method according to Embodiment 1 is shown in FIG. 8.

Referring to FIG. 6, an image encoding apparatus 100 may include a complexity calculation unit 610, a similarity calculation unit 620, a bit rate prediction unit 630, a distortion prediction unit 640, and a resolution selection unit 650.

The image encoding apparatus 100 may obtain information on complexity of a current image (S710). The obtaining (or calculating) the information on complexity in step S710 may be performed in the complexity calculation unit 610. The information on complexity may be obtained using the current image as input.

The image encoding apparatus 100 may obtain information on similarity between the current image and the reference image (S710). The obtaining (or calculating) the information on similarity in step S710 may be performed in the similarity calculation unit 620. The information on similarity may be obtained using the current image and the reference image as input or using a portion of the current image and the reference image as input.

The image encoding apparatus 100 may predict bit rate information of one or more candidate resolutions (S720). Prediction of the bit rate information may be performed in the bit rate prediction unit 640. The bit rate information may be predicted based on the information on complexity and the information on similarity. Depending on the embodiment, the bit rate information may be further predicted based on all or part of a quantization parameter (QP), a temporal layer identifier (Tid), a slice type, and a resolution.

The image encoding apparatus 100 may predict distortion information of the candidate resolutions (S720). Prediction of the distortion information may be performed in the distortion prediction unit 640. The distortion information may be predicted based on the information on complexity and the information on similarity. Depending on the embodiment, the distortion information may be further predicted further based on all or part of a quantization parameter (QP), a temporal layer identifier (Tid), a slice type, and a resolution.

The image encoding apparatus 100 may select a resolution (i.e., optimal resolution) to be applied to the current image from among the candidate resolutions (S730). Selection of the optimal resolution may be performed in the resolution selection unit 650.

The optimal resolution may be selected based on the bit rate information and the distortion information. For example, the image encoding apparatus 100 may calculate rate distortion cost for the candidate resolutions and select a candidate resolution with the lowest rate distortion cost as the optimal resolution.

The optimal resolution may be expressed as a ratio between the size of the current image and the size of the reference image (e.g., size of the reference image/size of the current image). The size of the image may be expressed as the width of the image, the height of the image, or the number of samples in the image (width×height). If the ratio between the size of the current image and the size of the reference image has a value greater than 1, such as 1.25, 1.5, 1.75, 2.0, etc., the size of the current image may be smaller than the size of the reference image. If the ratio between the size of the current image and the size of the reference image has a value smaller than 1, such as 0.25, 0.5, 0.75, etc., the size of the current image may be larger than the size of the reference image. The ratio between the size of the current image and the size of the reference image may be composed of only the ratios described above for ease of implementation, such as allowing only the shift operation to be performed without the division operation, or may have an arbitrary ratio (arbitrary value).

The optimal resolution may be determined in units such as CTU, slice, tile, frame, temporal layer, GOP or multiple of GOP, random access point (RAP), or multiple of RAP.

The image encoding apparatus 100 may encode information on the optimal resolution (information on the selected resolution). Depending on embodiments, the image encoding apparatus 100 may encode information on the optimal resolution and information on the candidate resolutions.

When the information on the optimal resolution is encoded, the image decoding apparatus 200 may obtain information on the optimal resolution (information on the selected resolution) from the bitstream (S820). Additionally, the image decoding apparatus 200 may select the optimal resolution of the current image based on the information on the optimal resolution (S830).

For example, the image decoding apparatus 200 may select the optimal resolution by selecting a candidate resolution indicated by the information on the optimal resolution from among predetermined candidate resolutions. The image decoding apparatus 200 may perform RPR by changing the resolution of the current image to the selected optimal resolution.

When the information on the optimal resolution and the information on the candidate resolutions are encoded, the image decoding apparatus 200 may obtain the information on the candidate resolutions from the bitstream (S810). The image decoding apparatus 200 may identify the candidate resolutions based on the information on the candidate resolutions.

The image decoding apparatus 200 may obtain the information on the optimal resolution (information on the selected resolution) from the bitstream (S820) and select the optimal resolution of the current image based on the information on the optimal resolution (S830).

For example, the image decoding apparatus 200 may select the optimal resolution by selecting the candidate resolution indicated by the information on the optimal resolution from among the candidate resolutions identified based on the information on the candidate resolutions. The image decoding apparatus 200 may perform RPR by changing the resolution of the current image to the selected optimal resolution.

### Embodiment 2

Embodiment 2 is an embodiment of a method of calculating information on complexity and information on similarity. That is, Embodiment 2 is an example of step S710 of FIG. 7.

The information on complexity may be 1) derived based on the sample value of a current image, 2) derived based on the result value of a video codec, or 3) derived using a machine learning-based neural network.

1) The sample value of the current image may be derived based on at least one of a sample unit average gradient value for the current image, a sample unit average gradient value difference between the luma component and the chroma component of the current image, a sample unit average transform value difference according to a change in resolution, or a sample unit average gradient value difference according to RPR application.

As an example, the sample unit average gradient value for the current image may be derived based on the sample value gradient between the current sample in the current image and neighboring samples located around the current sample. Here, the neighboring samples may be 4 samples or 8 samples located around the current sample.

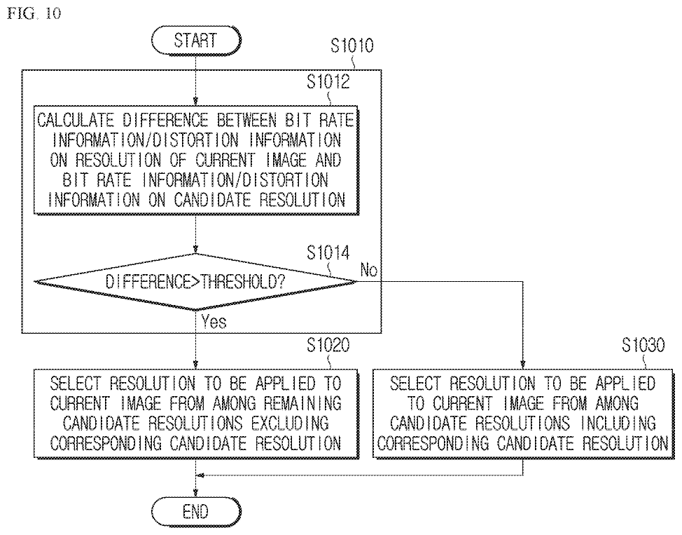

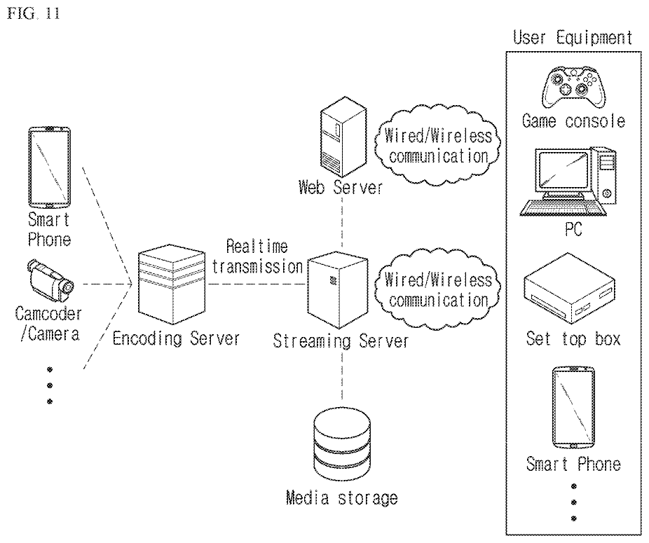

An example for explaining the positional relationship between the current sample and neighboring samples is shown in FIG. 9. In FIG. 9, X(i, j) represents the current sample, and the remaining samples except X(i, j) represent neighboring samples.

When using 4 neighboring samples, the sample value gradient may be calculated using two neighboring samples (X(i−1, j) sample and X(i+1, j) sample) in the horizontal direction and 2 neighboring samples (X(i, j−1) sample and X(i, j+1) sample) in the vertical direction. For example, the sample value gradient in each direction may be calculated according to Equation 1 below.

$$GH ( i , j ) = ( X ( i , j ) << 1 ) - X ( i - 1 , j ) - X ( i + 1 , j ) \\ GV ( i , j ) = ( X ( i , j ) << 1 ) - X ( i , j - 1 ) - X ( i , j - 1 ) \qquad [ Equation 1 ]$$

In Equation 1, GH(i, j) represents the sample value gradient in the horizontal direction, and GV(i, j) represents the sample value gradient in the vertical direction.

The sample unit average gradient using the calculated sample value gradient may be calculated according to Equation 2.

$$Gradient 4 = \frac{{\sum }_{i = 0 , j = 0}^{i = W - 1 , j = H - 1} ( GH ( i , j ) + GV ( i , j ) )}{W \times H} \qquad [ Equation 2 ]$$

In Equation 2, W and H are the areas for calculating the sample unit average gradient, and may be used in the form of all samples of the image, samples of some CTUs or some areas, sampled samples, samples with filtering applied, etc.

When using 8 neighboring samples, the sample value gradient using samples located in the diagonal direction may be additionally calculated based on the current sample. For example, the sample value gradient in the diagonal direction may be calculated according to Equation 3.

$$GD 1 ( i , j ) = ( X ( i , j ) << 1 ) - X ( i - 1 , j - 1 ) - X ( i + 1 , j + 1 ) \\ GD 2 ( i , j ) = ( X ( i , j ) << 1 ) - X ( i - 1 , j + 1 ) - X ( i + 1 , j - 1 ) \qquad [ Equation 3 ]$$

In Equation 3, GD1(i, j) represents the sample value gradient in the downward-right diagonal direction, and GD1(i, j) represents the sample value gradient in the upward-right diagonal direction.

The sample unit average gradient may be calculated according to the sample value gradient calculated based on 8 neighboring samples and Equation 4.

$$Gradient 8 = \frac{\begin{matrix}{\sum }_{i = 0 , j = 0}^{i = W - 1 , j = H - 1} ( GH ( i , j ) + \\ GV ( i , j ) + GD 1 ( i , j ) + GD 2 ( i , j ) )\end{matrix}}{W \times H} \qquad [ Equation 4 ]$$

As another example, the sample unit average gradient may be calculated for each of the luma component and chroma component of the current image, or may be calculated using a single equation. When the sample unit average gradient is calculated for each of the luma component and the chroma component, the sample unit average gradient value between the luma component and the chroma component of the current image may be calculated by calculating a difference between the sample unit average gradient of the luma component and the sample unit average gradient of the chroma component.

As another example, the sample unit average gradient may be calculated according to the change in resolution. For example, the difference between the sample unit average gradient of the original size of the current image (resolution of the current image) and the sample unit average gradient of the current image with the changed resolution may be calculated.

As another example, the sample unit average gradient according to the change in resolution may be calculated. In this case, after performing resampling to change the current image to a desired resolution and reconstructing it back to the original resolution (original image size), the difference between the sample unit average gradient of the original size of the current image (resolution of the current image) and the sample unit average gradient of the current image with the reconstructed resolution may be calculated.

As another example, without calculating the sample unit average gradient, a peak signal to noise ratio (PSNR) or structural similarity index map (SSIM) between the reconstructed current image and the original image may be calculated and derived as information on complexity.

2) When deriving information on complexity based on the result value of the video codec, the entire current image, some CTUs within the current image, or a partial area of the current image may be input to a video codec and the result may be provided as information on complexity.

As an example, the current image is losslessly encoded using a video codec such as advanced video coding (AVC), high efficiency video coding (HEVC), or VVC, or the current image is lossy encoded using a predetermined quantization parameter, and information on complexity may be obtained based on the result. Here, the information on complexity may include an average bit rate of a specific unit, an average PSNR of a specific unit, a slice type, etc.

3) When deriving information on complexity using a machine learning-based neural network, the entire current image, some CTUs of the current image, or a partial area of the current image may be used as input to the neural network. The output result of the neural network may be a quantitative constant value expressing the complexity included in the current image, and this constant value may be information on complexity. Alternatively, applicability (binary result of 0 or 1) of the methods proposed herein may be the output of the neural network.

Meanwhile, information on similarity may also be 1) derived based on the sample value of the current image, 2) derived based on the result value of the video codec, or 3) derived using a machine learning-based neural network.

1) The deriving of the information on similarity based on the sample value of the current image, 2) the deriving of the information on similarity based on the result value of the video codec, and 3) the deriving of the information on similarity using the machine learning-based neural network may be performed according to the same method as the specific method of deriving information on complexity described above.

The information on similarity may be information that may quantitatively indicate similarity (redundancy) between the current image and the reference image. For example, the information on similarity may be a cross correlation value between the current image and the reference image, or a sample value gradient (or sample unit average gradient value) between the current image and the reference image.

### Embodiment 3

Embodiment 3 is an embodiment of a method of predicting bit rate information. That is, Embodiment 3 is an embodiment of step S720 of FIG. 7.

The bit rate information may be predicted based on information on complexity and information on similarity. Depending on embodiments, the bit rate information of a given resolution (candidate resolution) may be predicted based not only on information on complexity and information on similarity, but also on a quantization parameter, a temporal layer identifier, a slice type, a resolution, etc.

All or some of the quantization parameter, temporal layer identifier, slice type, and resolution may be used to predict bit rate information. Additionally, some of the quantization parameter, temporal layer identifier, slice type, and resolution may be modified and used to predict bit rate information. As an example, the quantization parameter may be modified and used as a quantization step value defined by the quantization parameter. As another example, the quantization parameter may be a quantization parameter before changing the resolution of the current image, or may be a quantization parameter with an offset applied within a predetermined range.

The bit rate information may be predicted according to Equation 5 (bit rate information prediction model) below.

$${ER}_{i} = a \times G \times {QS}_{j}^{b} \qquad [ Equation 5 ]$$

In Equation 5, ERi represents the bit rate information predicted for the resolution of i, and G represents the sample unit average gradient for the current image. G may be calculated only once from the size of the current image, or may be calculated separately for each resolution. Alternatively, G may be changed or added by one or more of the information on complexity of Embodiment 2. QSj represents a quantization step size when the quantization parameter value is equal to j. a and b are scale values that may predict bit rate information when input parameters are given, and may be pre-trained coefficients. a and b may be derived based on machine learning. For example, a and b may be derived through linear regression or a neural network.

The bit rate information prediction model may vary depending on the resolution of the current image, the number of samples included in the current image, and information on the range or complexity of the quantization parameter.

### Embodiment 4

Embodiment 4 is an embodiment of a method of predicting distortion information, and is an embodiment of step S720 of FIG. 7.

The distortion information may indicate distortion (of candidate resolutions) according to the change in resolution. After image quality values such as PSNR or SSIM of candidate resolutions are first predicted, distortion information may be predicted based on this.

The distortion information may be predicted based on information on complexity and information on similarity. Depending on embodiments, distortion information of a given resolution (candidate resolution) may be predicted based not only on information on complexity and information on similarity, but also on a quantization parameter, a temporal layer identifier, a slice type, a resolution, etc.

All or some of the quantization parameter, temporal layer identifier, slice type, and resolution may be used to predict distortion information. Additionally, some of the quantization parameter, temporal layer identifier, slice type, and resolution may be modified and used to predict distortion information. As an example, the quantization parameter may be modified and used as a quantization step value defined by the quantization parameter. As another example, the quantization parameter may be a quantization parameter before changing the resolution of the current image, or may be a quantization parameter with an offset applied within a predetermined range.

The distortion information (e.g., PSNR) may be predicted according to the distortion information prediction model of Equation 6 below.

$${EPSNR}_{i} = a \times R + b \times QP + c \times G \qquad [ Equation 6 ]$$

In Equation 6, ESPSNRi represents distortion information predicted for the resolution of i, and G represents the sample unit average gradient for the current image. G may be calculated only once from the size of the current image, or may be calculated separately for each resolution. R represents the resolution of the current image, and QP represents the quantization parameter value. a, b, and c are scale values that may predict distortion information when input parameters are given, and may be pre-trained coefficients. a, b and c may be derived based on machine learning. For example, a, b, and c may be derived through linear regression or a neural network, etc.

The distortion information prediction model of Equation 6 may vary depending on the resolution of the current image (or the number of samples included in the current image), quantization parameters, sample unit average gradient, information on complexity, etc. In other words, the distortion information may be predicted using a distortion information prediction model changed according to the resolution of the current image (or the number of samples included in the current image), quantization parameters, sample unit average gradient, information on complexity, etc.

As an example, the distortion information may be predicted through the distortion information prediction model of Equation 7, which uses the quantization parameter in the form of a square.

$${EPSNR}_{i} = a \times R + b \times {QP}^{2} + c \times G \qquad [ Equation 7 ]$$

As another example, the distortion information may be predicted through the distortion information prediction model of Equation 8, which combines the resolution with the quantization parameter and the sample unit average gradient.

$${EPSNR}_{i} = a \times QP + b \times QP \times R + x \times G + d \times G \times R \qquad [ Equation 8 ]$$

In Equation 8, d is a scale value that may predict distortion information when input parameters are given, and may be a pre-trained coefficient. d may be derived based on machine learning. For example, d may be derived through linear regression or a neural network.

As another example, the distortion information may be predicted through the distortion information prediction model of Equation 9, which combines resolution with the quantization parameter and sample unit average gradient and uses the quantization parameter in the form of a square.

$${EPSNR}_{i} = a \times {QP}^{2} + b \times QP \times R + c \times G + d \times G \times R \qquad [ Equation 9 ]$$

### Embodiment 5

Embodiment 5 is an embodiment of a method of selecting an optimal resolution, and is an embodiment of step S730 of FIG. 7.

Based on the bit rate information and distortion information, a resolution (optimal resolution) to be applied to the current image may be selected from among the candidate resolutions. For example, a candidate resolution which minimizes bit rate distortion cost may be selected from among the candidate resolutions as an optimal resolution. The candidate resolutions that may be selected as the optimal resolution may have a resolution larger or smaller than the input image.

Depending on the embodiment, the optimal resolution may be selected according to the resolution selection model of Equation 10.

$$OR = argmin ( {ER}_{i} \times λ + {EPSNR}_{i} ) \qquad [ Equation 10 ]$$

In Equation 10, OR (optimal resolution) represents the optimal resolution, ERi represents bit rate information for the resolution of i, and EPSNRi represents distortion information for the resolution of i. λ is a constant defined by the quantization parameter given to encode the current image. According to argmin of Equation 10, resolution i which minimizes bit rate distortion cost may be determined from among the candidate resolutions as the optimal resolution.

Using the optimal resolution selection model of Equation 10, it is possible to determine the optimal resolution and at the same time determine the optimal quantization parameter. The selectable quantization parameter value (candidate quantization parameter value) may be input as the same value to the bit rate prediction unit 630 and the distortion prediction unit 640 for prediction of the bit rate information and the distortion information, and the bit rate distortion cost corresponding thereto may be calculated. That is, through Equation 10, the optimal resolution and optimal quantization parameter that minimize the bit rate distortion cost may be determined at once.

Depending on the embodiments, Equation 10 may be applied to all candidate resolutions, or may be applied to only some of the candidate resolutions. For example, among candidate resolutions, a candidate resolution that does not satisfy a predetermined condition may be excluded without being input into the optimal resolution selection process. Here, the candidate resolutions may include the resolution of the current image.

The predetermined condition may be at least one of whether a difference between the bit rate value (bit rate information or expected bit amount) for the resolution of the current image and the bit rate value (bit rate information or expected bit amount) of the candidate resolution exceeds a threshold, or whether a difference between the distortion value (distortion information or expected distortion) for the resolution of the current image and the distortion value (distortion information or expected distortion) of the candidate resolution exceeds a threshold.

As an example, the image encoding apparatus 100 may select a candidate resolution in which the difference between bit rate information of the resolution of the current image and bit rate information of the candidate resolution exceeds a threshold (S1010). Specifically, the image encoding apparatus 100 may select candidate resolutions in which the calculated difference exceeds a threshold, by calculating the difference between the bit rate information of the resolution of the current image and the bit rate information of the candidate resolution (S1012) and determining whether the calculated difference exceeds the threshold (S1014).

If the calculated difference exceeds the threshold, the image encoding apparatus 100 may select the optimal resolution from among the remaining candidate resolutions excluding the corresponding candidate resolution (S1020). If the calculated difference does not exceed the threshold, the image encoding apparatus 100 may select an optimal resolution from among the candidate resolutions including the corresponding candidate resolution (S1030).

As another example, the image encoding apparatus 100 may select the candidate resolution in which the difference between distortion information of the resolution of the current image and distortion information of the candidate resolution exceeds a threshold (S1010). Specifically, the image encoding apparatus 100 may select the candidate resolution in which the calculated difference exceeds the threshold, by calculating the difference between distortion information of the resolution of the current image and distortion information of the candidate resolution (S1012) and determining whether the calculated difference exceeds the threshold (S1014).

If the calculated difference exceeds the threshold, the image encoding apparatus 100 may select the optimal resolution from among the remaining candidate resolutions excluding the corresponding candidate resolution (S1020). If the calculated difference does not exceed the threshold, the image encoding apparatus 100 may select the optimal resolution from among candidate resolutions including the corresponding candidate resolution (S1030).

In this way, when excluding candidate resolution in which the calculated difference exceeds the threshold, since the optimal resolution selection process may be applied to a relatively small number of candidate resolutions, it is possible to reduce the complexity of the process of selecting the optimal resolution.

FIG. 11 is a view illustrating a content streaming system, to which an embodiment of the present disclosure is applicable.

As shown in FIG. 11, the content streaming system, to which the embodiment of the present disclosure is applied, may largely include an encoding server, a streaming server, a web server, a media storage, a user device, and a multimedia input device.

The encoding server compresses content input from multimedia input devices such as a smartphone, a camera, a camcorder, etc. into digital data to generate a bitstream and transmits the bitstream to the streaming server. As another example, when the multimedia input devices such as smartphones, cameras, camcorders, etc. directly generate a bitstream, the encoding server may be omitted.

The bitstream may be generated by an image encoding method or an image encoding apparatus, to which the embodiment of the present disclosure is applied, and the streaming server may temporarily store the bitstream in the process of transmitting or receiving the bitstream.

The streaming server transmits the multimedia data to the user device based on a user's request through the web server, and the web server serves as a medium for informing the user of a service. When the user requests a desired service from the web server, the web server may deliver it to a streaming server, and the streaming server may transmit multimedia data to the user. In this case, the content streaming system may include a separate control server. In this case, the control server serves to control a command/response between devices in the content streaming system.

The streaming server may receive content from a media storage and/or an encoding server. For example, when the content is received from the encoding server, the content may be received in real time. In this case, in order to provide a smooth streaming service, the streaming server may store the bitstream for a predetermined time.

Examples of the user device may include a mobile phone, a smartphone, a laptop computer, a digital broadcasting terminal, a personal digital assistant (PDA), a portable multimedia player (PMP), navigation, a slate PC, tablet PCs, ultrabooks, wearable devices (e.g., smartwatches, smart glasses, head mounted displays), digital TVs, desktops computer, digital signage, and the like.

Each server in the content streaming system may be operated as a distributed server, in which case data received from each server may be distributed.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

The embodiments of the present disclosure may be used to encode or decode an image.

What is claimed is:

1. An image encoding method performed by an image encoding apparatus, the image encoding method comprising:
obtaining information on similarity between a current image and a reference image and information on complexity of the current image;
predicting bit rate information and distortion information of one or more candidate resolutions based on the information on similarity and the information on complexity; and
selecting a resolution to be applied to the current image from among the candidate resolutions based on the bit rate information and the distortion information.

2. The image encoding method of claim 1, wherein the information on complexity is obtained based on a sample value of the current image.

3. The image encoding method of claim 2, wherein the information on complexity is obtained based on a sample value gradient between one or more neighboring samples located around a current sample in the current image and the current sample.

4. The image encoding method of claim 3, wherein the neighboring samples comprise neighboring samples located to the left and right of the current sample and neighboring samples located above and below the current sample.

5. The image encoding method of claim 2, wherein the information on complexity is obtained based on a sample value gradient between a luma sample of the current image and a chroma sample of the current image.

6. The image encoding method of claim 1, wherein the information on similarity is information on cross correlation between the current image and the reference image or a sample value gradient between the current image and the reference image.

7. The image encoding method of claim 1, wherein the bit rate information is further predicted based on one or more of information on a quantization parameter, information on a temporal layer identifier, information on a slice type, or information on a resolution.

8. The image encoding method of claim 7, wherein the information on the quantization parameter is a quantization step value defined by the quantization parameter.

9. The image encoding method of claim 7, wherein the quantization parameter is a quantization parameter of the current image.

10. The image encoding method of claim 1, wherein the distortion information is further predicted based on one or more of information on a quantization parameter, information on a temporal layer identifier, information on a slice type, or information on a resolution.

11. The image encoding method of claim 1, wherein the resolution to be applied to the current image is selected as a candidate resolution which minimizes rate distortion cost among the candidate resolutions.

12. The image encoding method of claim 1, wherein the selecting comprising:
selecting a candidate resolution in which a difference between bit rate information on a resolution of the current image and the bit rate information exceeds a threshold; and
selecting a resolution to be applied to the current image from among the remaining candidate resolutions excluding a candidate resolution exceeding the threshold.

13. The image encoding method of claim 1, wherein the selecting comprising:
selecting a candidate resolution in which a difference between distortion information on a resolution of the current image and the distortion information exceeds a threshold; and
selecting a resolution to be applied to the current image from among the remaining candidate resolutions excluding a candidate resolution exceeding the threshold.

14. A method of transmitting a bitstream generated by an image encoding method, the image encoding method comprising:
obtaining information on similarity between a current image and a reference image and information on complexity of the current image;
predicting bit rate information and distortion information of one or more candidate resolutions based on the information on similarity and the information on complexity; and
selecting a resolution to be applied to the current image from among the candidate resolutions based on the bit rate information and the distortion information.

15. A computer-readable recording medium storing a bitstream generated by an image encoding method, the image encoding method comprising:
obtaining information on similarity between a current image and a reference image and information on complexity of the current image;
predicting bit rate information and distortion information of one or more candidate resolutions based on the information on similarity and the information on complexity; and
selecting a resolution to be applied to the current image from among the candidate resolutions based on the bit rate information and the distortion information.
